(19) United States
(12) Patent Application Publication
(10) Pub. No.: US 2006/0283353 A1
(43) Pub. Date: Dec. 21, 2006

(54) Ink for color filter

(75) Inventor: Wei-Yuan Chen, Hsinchu (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: ICF Technology Co., Ltd., Hsinchu City (TW)

(21) Appl. No.: 11/437,941

(22) Filed: May 19, 2006

(30) Foreign Application Priority Data
Jun. 17, 2005 (CN) 200510035398.3

(51) Int. Cl. C09D 11/00

(52) U.S. Cl. 106/31.57

(57) ABSTRACT

Ink for a color filter contains by weight colorant in an amount of 0.1 to 40 percent, solvent in an amount of 1 to 95 percent, initiator in an amount of 0.01 to 15 percent, oligomers in an amount of 0.5 to 80 percent.

### BACKGROUND

1. Technical Field

The present invention relates generally to ink for making a color filter, and more particularly, to cross-linking ink for making a color filter.

2. Discussion of Related Art

A color filter is one of the most important elements in a liquid crystal display device. The color filters are generally used in the liquid crystal display devices for converting white light transmitted therethrough into red (R) light, green (G) light and blue (B) light. The red light, the green light and the blue light are configured for liquid crystal display (LCD) devices that display color images.

Conventional methods for manufacturing the color filters mostly include a pigment-dispersed method and an ink jet method.

The pigment-dispersed method is widely used as a manufacturing method for color filter. The pigment-dispersed method uses color pigment photoresists forming red, green and blue sub-pixels by means of a spin-exposure-development process. Specifically, red pigment photoresist, blue pigment photoresist and green pigment photoresist are sequentially coated on the glass substrate with the black matrix, exposed to the ultraviolet-light with the help of photomask after drying, and developed to respectively form red sub-pixels, green sub-pixels and blue sub-pixels color layer. Since the process has to be repeated three times or more, these manufacturing devices are both expensive to use and time-consuming to operate.

The ink jet method is different from other conventional methods and is a method in which each of the R, G, and B inks are sprayed onto a substrate from the respective nozzles to form a color layer. When this method is employed, the required amount of ink can be applied onto a required place at a specific time. Accordingly, there is no waste of ink. Furthermore, since the sub-pixels of R, G, and B can be formed simultaneously, the printing process is shortened, and it is possible to markedly reduce cost.

However, when ejecting ink onto a sub-pixel defined on the substrate such as a glass substrate without an ink-receiving layer, the ink floods one sub-pixel, and tends to overflow into an adjacent sub-pixels and mix with the ink therein. So the ink ejected onto a sub-pixel without an ink-receiving layer must be cross-linking ink. The cross-linking ink can be fixed on the glass substrate after heating or exposure to ultraviolet radiation.

Since high requirements of the adhesive characteristics, mechanical strength and physicochemical property of color filters, the conventional photoresists always contain compositions including reactive monomers, solvents, initiators, polymer resins, dispersants, pigments and other additives. Each component achieves some good properties corresponding to the requirements. Although inkjet ink for color filter does not need some properties like the requirements from developing process, but most of the requirements are the same. Besides, since nozzles of ink jet are very small, any instability of ink forming particles will be possible to block the nozzles. Complex ink compositions similar to photoresists will not be allowed, since they will induce long-term instability and induce the defects in inkjet process.

What is needed, therefore, is ink with simplified compositions by decreasing or eliminating polymer resins for a color filter, also with good adhesion and high stability.

### SUMMARY

In one aspect the invention, ink for a color filter is provided. The ink contains by weight, colorant in an amount of 0.1 to 40 percent, solvent in an amount of 1 to 95 percent, initiator in an amount of 0.01 to 15 percent, oligomers in an amount of 0.5 to 80 percent.

This enhances the adhesive characteristics and stability of the ink by minimizing or avoid usage of polymer resin. Other advantages and novel features of the present invention will become more apparent from the following detailed description of preferred embodiments.

Other advantages and novel features of the present ink for color filter will become more apparent from the following detailed description of preferred embodiments when taken in conjunction with the accompanying drawings.

### DETAILED DESCRIPTION OF PREFERRED EMBODIMENTS

Reference will now be made to describe embodiments of the present invention.

The present ink for a color filter comprises by weight, colorant in an amount of 0.1 to 40 percent, solvent in an amount of 1 to 95 percent, initiator in an amount of 0.01 to 15 percent, oligomers in an amount of 0.5 to 80 percent.

Preferably, the amount by weight of the colorant is in the range from 3 to 15 percent, the amount by weight of the solvent is in the range from 25 to 85 percent, the amount by weight of the initiator is in the range from 0.1 to 8 percent, and the amount by weight of the oligomers is in the range from 3 to 65 percent.

The colorant is comprised of a material selected from the group consisting of dyestuff, pigment and a combination thereof. The familiar red pigment includes pigment red 122, pigment red 177, pigment red 185, pigment red 202, pigment red 206, pigment red 207, pigment red 209, pigment red 224, pigment red 254, pigment red 264. The familiar blue pigment includes pigment blue 15:3, pigment blue 15:4, pigment blue 15:6. The familiar green pigment includes pigment green 7, pigment green 36.

The solvent is organic solvent, and the organic solvent mostly includes ester, ether, alcohol ether, ketone, alcohol, polyhydric alcohol derivant, nitrogen-containing solvent and so on. More specifically, the preferred solvent is selected from the group consisting of methoxybutanol, isopropyl alcohol, butanol, benzyl alcohol, butyl ether, THF, ethylene glycol propyl ether, ethylene glycol butyl ether, ethylene glycol benzyl ether, ethylene glycol butyl ether acetate, diethylene glycol dimethyl ether, diethylene glycol monoethyl ether, diethylene glycol monobutyl ether, diethylene glycol hexyl ether, triethylene glycol monomethyl ether, triethylene glycol monoethyl ether, triethylene glycol monobutyl ether, propylene glycol monomethyl ether, propylene glycol methyl ether acetate, propylene glycol monobutyl ether, tripropylene glycol monobutyl ether, propylene glycol benzyl ether, ethyl acetate, butyl acetate, benzoic acid ethyl ester, ethyl 3-ethoxy propionate, acetone, methyl ethyl ketone, methyl n-amyl ketone, methyl isobutyl ketone, diisobutylketone (DIBK), isophorone, cyclohexanone (CYC), 2-pyrrolidene ketone, N-methyl-2-pyrrolidene ketone, and dimethyl sulfoxide (DMSO).

The initiator used can be thermal initiator and/or photo initiator. The thermal initiator is selected from the group consisting of benzoyl peroxide (BPO) and 2,2-azobis isobutyronitrile (AIBN) etc. The photo initiator is selected from the group consisting of 4,4-Bis(dimethylamino) Benzophenone, 4,4-Bis(Diethylamino)Benzophenone, 2-(4-Methoxyphenyl)-4,6-Bis(Trichloromethyl)-1,3,5-Triazine, and Tris(trichloromethyl)-1,3,5-Triazine. Presently, the product of the photo initiator mostly includes IRGACURE®819, IRGACURE®369, IRGACURE®2959, IRGACURE®379, IRGACURE®184, IRGACURE®784, IRGACURE®250, IRGACURE®907, IRGACURE®0651, IRGACURE®OXE01, IRGACURE®OXE02, IRGACURE®500, IRGACURE®1800, IRGACURE®1000, IRGACURE®1700, DAROCURE®BP, DAROCURE®1173 CGI-242, DAROCURE®1173 CGI-552, CHIVACURE®TPO, CHIVACURE®TPO-L, CHIVACURE®200, CHIVACURE®107, CHIVACURE®184, or CHIVACURE®284.

The oligomers includes at least one of organic unsaturated hydrocarbon and unsaturated polyester oligomers. The organic unsaturated hydrocarbon or unsaturated polyester oligomers is selected from the group consisting of epoxy acrylate oligomers, epoxy methyl acrylate oligomers, polyester acrylate oligomers, urethane methyl acrylate oligomers, urethane acrylate oligomers, amine modified epoxy acrylate oligomers, amine modified polyester acrylate oligomers, polybutadiene acrylate oligomers, acrylate oligomers, diacrylate oligomers, triacrylate oligomers, metallic acrylate oligomers and usethane oligomers.

The oligomers as described above can comprise one or more functional groups by modification. The modified functional groups selected from the group consisting of hydroxyl group (—OH), hydrogencyanato (—HCN), amino group (—NH), isocyanato (—NCO), carboxy (—COOH), —SH, eposy group, vinyl group, benzene ring, amide group, ester, usethane, siloxane, sulfide, acid anhydride, urea resin, carbonic acid, phosphate ester and sulfone.

Optionally, some additives may be added to the ink. The amount by weight of the additive is in the range from 0 to 30 percent, and preferably ranges from 0.1 to 10 percent. The additive is used to change the property of the ink so as to match with the production requirements, thereby to obtain a product having better property and specification. The additive is comprised of a material selected from the group consisting of surfactant, dispersant, antifoaming agent, defoamer, leveling agent, anti-settling agent, adhesion promoter, thickening agent and any combination thereof.

The surfactant is mostly used to control surface tension of the ink, the preferred material is selected from the group consisting of siloxane containing organic compounds, fluorine-containing organic compounds, polyoxyethylene-containing compounds.

The dispersant is mostly used to enhance dispersion stability of the colorant, the preferred material is selected from the group consisting of acrylate type or modified acrylate type organic compound, and urethane type or modified urethane type organic compounds. Presently, the dispersant agent product mostly includes Solsperse 5000, Solsperse 1700, Solsperse 20000, Solsperse 24000, Solsperse 32500 etc.

The antifoaming agent and defoamer are used to restrain and slate air bubble generated in the ink, the preferred material is selected from the group consisting of siloxane-containing organic compounds, polyoxyethylene-containing organic compounds.

In addition, the leveling agent is mostly used to control smoothness of film. The anti-settling agent is mostly used to prevent the colorant depositing. The adhesion promoter sealant is mostly used to enhance adhesive characteristics of the ink. The thickening agent is mostly used to adjust viscosity of the ink.

A first embodiment of the ink provides a red ink, containing: 5.25 wt % (percentage by weight) of modified pigment red 254, 10 wt % of urethane acrylate oligomer, 2 wt % of IRGACURE®184, 80 wt % of propylene glycol methyl ether acetate and 2.75 wt % of Solsoerse 24000.

A second embodiment of the ink provides a red ink, containing: 5.25 wt % of modified pigment red 254, 6 wt % of urethane acrylate oligomer, 1 wt % of IRGACURE®907, 85 wt % of ethyl 3-ethoxy propionate and 2.75 wt % of Solsoerse 24000.

A third embodiment of the ink provides a red ink, containing: 6 wt % of modified pigment red 254, 6 wt % of acrylate oligomer, 1 wt % of IRGACURE®184, 82 wt % of propylene glycol methyl ether acetate, 3 wt % of cyclohexanone and 2 wt % of Solsoerse 24000.

A fourth embodiment of the ink provides a green ink, containing: 4 wt % of modified pigment green 36, 6 wt % of polyester acrylate oligomer, 1 wt % of IRGACURE®907, 77 wt % of propylene glycol methyl ether acetate, 8 wt % of propylene glycol methyl ether and 4 wt % of Solsoerse 24000.

A fifth embodiment of the ink provides a red ink, containing: 3.2 wt % of modified pigment red 254, 80 wt % of polyester acrylate oligomer, 6 wt % of IRGACURE®184, 9.8 wt % of propylene glycol methyl ether acetate, and 1 wt % of Solsoerse 24000.

A sixth embodiment of the ink provides a green ink, containing: 5.25 wt % of modified pigment green 36, 0.5 wt % of epoxy acrylate oligomers, 5 wt % of IRGACURE®184, 72 wt % of ethyl 3-ethoxy propionate, 6.5 wt % of dipentaerythritol pentaacrylate, 8 wt % of cyclohexanone and 2.75 wt % of Solsoerse 24000.

The present ink for a color filter employs oligomers or modified oligomers thereby eliminates the need for employing polymer resin and reactive monomer. Therefore, the inventive ink advantageously has good adhesive characteristics and high stability. The oligomers or modified oligomers may have functional group such as hydroxyl group (—OH), hydrogencyanato (—HCN), amino group (—NH), isocyanato (—NCO), carboxy (—COOH), —SH, epoxy group and so on. Even though no polymer resin is added into the ink, the ink also has good adhesive characteristics and interrelated properties such as heat-resistance, optical properties and so on.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. Ink for a color filter, comprising:
by weight, colorant in an amount of 0.1 to 40 percent, solvent in an amount of 1 to 95 percent, initiator in an amount of 0.01 to 15 percent, oligomers in an amount of 0.5 to 80 percent.

2. The ink as claimed in claim 1, wherein the amount by weight of the colorant is in the range from 3 to 15 percent.

3. The ink as claimed in claim 1, wherein the amount by weight of the solvent is in the range from 25 to 85 percent.

4. The ink as claimed in claim 1, wherein the amount by weight of the initiator is in the range from 0.1 to 8 percent.

5. The ink as claimed in claim 1, wherein the amount by weight of the oligomers is in the range from 3 to 65 percent.

6. The ink as claimed in claim 1, wherein the colorant is comprised of a material selected from the group consisting of dyestuff, pigment and a combination thereof.

7. The ink as claimed in claim 6, wherein the pigment is selected from the group consisting of pigment red 122, pigment red 177, pigment red 185, pigment red 202, pigment red 206, pigment red 207, pigment red 209, pigment red 224, pigment red 254, pigment red 264, pigment blue 15:3, pigment blue 15:4, pigment blue 15:6, pigment green 7, pigment green 36.

8. The ink as claimed in claim 1, wherein the solvent is an organic solvent.

9. The ink as claimed in claim 8, wherein the organic solvent is selected from the group consisting of ester, ether, alcohol ether, ketone, alcohol, polyhydric alcohol derivative and nitrogen-containing solvent.

10. The ink as claimed in claim 9, wherein the organic solvent is selected from the group consisting of methoxybutanol, isopropyl alcohol, butanol, benzyl alcohol, butyl ether, THF, ethylene glycol propyl ether, ethylene glycol butyl ether, ethylene glycol benzyl ether, ethylene glycol butyl ether acetate, diethylene glycol dimethyl ether, diethylene glycol monoethyl ether, diethylene glycol monobutyl ether, diethylene glycol hexyl ether, triethylene glycol monomethyl ether, triethylene glycol monoethyl ether, triethylene glycol monobutyl ether, propylene glycol monomethyl ether, propylene glycol methyl ether acetate, propylene glycol monobutyl ether, tripropylene glycol monobutyl ether, propylene glycol benzyl ether, ethyl acetate, butyl acetate, benzoic acid ethyl ester, ethyl 3-ethoxy propionate, acetone, methyl ethyl ketone, methyl n-amyl ketone, methyl isobutyl ketone, diisobutylketone, isophorone, cyclohexanone, 2-pyrrolidene ketone, N-methyl-2-pyrrolidene ketone, and dimethyl sulfoxide.

11. The ink as claimed in claim 1, wherein the initiator is either thermal initiator or photo initiator or both.

12. The ink as claimed in claim 11, wherein the thermal initiator is selected from the group consisting of benzoyl peroxide and 2,2-azobis isobutyronitrile.

13. The ink as claimed in claim 11, wherein the photo initiator is selected from the group consisting of 4,4-Bis(dimethylamino) Benzophenone, 4,4-Bis(Diethylamino)Benzophenone, 2-(4-Methoxyphenyl)-4,6-Bis(Trichloromethyl)-1,3,5-Triazine, and Tris(trichloromethyl)-1,3,5-Triazine.

14. The ink as claimed in claim 1, wherein the oligomers comprise at least one of organic unsaturated hydrocarbon and unsaturated polyester oligomers.

15. The ink as claimed in claim 14, wherein the organic unsaturated hydrocarbon or unsaturated polyester oligomers is selected from the group consisting of epoxy acrylate oligomers, epoxy methyl acrylate oligomers, polyester acrylate oligomers, urethane methyl acrylate oligomers, urethane acrylate oligomers, amine modified epoxy acrylate oligomers, amine modified polyester acrylate oligomers, polybutadiene acrylate oligomers, acrylate oligomers, diacrylate oligomers, triacrylate oligomers, metallic acrylate oligomers and usethane oligomers.

16. The ink as claimed in claim 1, wherein the oligomer comprises one or more functional groups selected from the group consisting of —OH, —HCN, —NH, —NCO, —COOH, —SH, epoxy group, vinyl group, benzene ring, amide group, ester, usethane, siloxane, sulfide, acid anhydride, urea resin, carbonic acid, phosphate ester and sulfone.

17. The ink as claimed in claim 1, wherein the ink further comprises additive in an amount by weight of 0 to 30 percent.

18. The ink as claimed in claim 17, wherein the amount by weight of the additive is in the range from 0.1 to 10 percent.

19. The ink as claimed in claim 17, wherein the additive is comprised of a material selected from the group consisting of surfactant, dispersant, antifoaming agent, defoamer, leveling agent, anti-settling agent, adhesion promoter, thickening agent and any combination thereof.

20. The ink as claimed in claim 19, wherein the surfactant is selected from the group consisting of siloxane-containing organic compounds, fluorine-containing organic compounds, and polyoxyethylene-containing organic compounds.

21. The ink as claimed in claim 19, wherein the dispersant is selected from the group consisting of acrylate type or modified acrylate type organic compounds, and urethane type or modified urethane type organic compounds.

22. The ink as claimed in claim 19, wherein the antifoaming agent and defoamer are selected from the group consisting of siloxane-containing organic compounds, and polyoxyethylene-containing organic compounds.
